(19) United States
(12) Patent Application Publication
(10) Pub. No.: US 2025/0345812 A1
(43) Pub. Date: Nov. 13, 2025

(54) ROTARY NOZZLE STRUCTURE

(71) Applicant: Nanjing Xinyi Technology Co., Ltd., Nanjing (CN)

(72) Inventor: Zhenzhong YUAN, Nanjing (CN)

(73) Assignee: Nanjing Xinyi Technology Co., Ltd., Nanjing (CN)

(21) Appl. No.: 19/001,223

(22) Filed: Dec. 24, 2024

(30) Foreign Application Priority Data
May 13, 2024 (CN) 2024105900096

(51) Int. Cl. B05B 3/10

(52) U.S. Cl. CPC B05B 3/1035

(57) ABSTRACT

The present invention discloses a rotary nozzle structure, including that a middle portion of the first center rod protrudes outwards to form an annular portion; the first reset spring, the driven wheel, the fixed cover are sequentially sleeved on an upper end of the first center rod, where two ends of the first reset spring respectively abut against the annular portion and the driven wheel, and the driven wheel is in matched transmission with the fixed cover; a rotating seat extends into the fixed cover and is sleeved on the first center rod, and the rotating seat is matched with the driven wheel through a sawtooth structure; the nozzle seat structure is sleeved on the rotating seat and is fixedly mounted on the fixed cover through the nut; the sheath is mounted on the upper end of the first center rod.

### CROSS-REFERENCE TO RELATED APPLICATIONS

The application claims priority to Chinese patent application No. 2024105900096, filed on May 13, 2024, the entire contents of which are incorporated herein by reference.

### TECHNICAL FIELD

The present invention relates to the related technical field of nozzles and the like, and in particular, to a rotary nozzle structure.

### BACKGROUND

Currently, a nozzle has a wide application range, and the use of the nozzle can increase cleaning area, effectively increase cleaning speed, and accelerate cleaning efficiency. However, at present, the nozzle is replaced in a form such as snap-fitting, causing that the nozzle is difficult to replace, and the replacement speed is low.

### SUMMARY

In view of this, to solve the foregoing problem, an object of the present invention is to provide a rotary nozzle structure, including:
a first center rod, a first reset spring, a driven wheel, a fixed cover, a rotating seat, a nut, a nozzle seat structure, a sheath, a second reset spring, a second center rod, and a locking nut; where
a middle portion of the first center rod protrudes outwards to form an annular portion;
the first reset spring, the driven wheel, the fixed cover are sequentially sleeved on an upper end of the first center rod, where two ends of the first reset spring respectively abut against the annular portion and the driven wheel, and the driven wheel is in matched transmission with the fixed cover;
the rotating seat extends into the fixed cover and is sleeved on the first center rod, and the rotating seat is matched with the driven wheel through a sawtooth structure;
the nozzle seat structure is sleeved on the rotating seat and is fixedly mounted on the fixed cover through the nut;
the sheath is mounted on the upper end of the first center rod, and an inner wall of the sheath is in matched transmission with the driven wheel through a clamping point structure;
the second reset spring is sleeved on a lower end of the first center rod;
the second center rod is mounted on the first center rod, and two ends of the second reset spring respectively abut against the sheath and the second center rod; and
the locking nut is mounted on the second center rod.

According to the foregoing rotary nozzle structure, the nozzle seat structure includes: a rectifier, a nozzle seat spring, a nozzle seat, a nozzle seat sheath, and a nozzle. The nozzle seat sheath is sleeved on the rotating seat and is fixedly mounted on the fixed cover through the nut, an upper end of the rotating seat is provided with a first mounting hole and a second mounting hole, the rectifier is mounted on the nozzle seat, the nozzle seat is correspondingly mounted on the first mounting hole and the second mounting hole, and the nozzle seat spring is located between the nozzle seat and the rotating seat, and the several nozzles are mounted on the nozzle seat sheath.

According to the foregoing rotary nozzle structure, the driven wheel extends upwards to be provided with several first clamping blocks, a bayonet is formed between every two adjacent first clamping blocks, and a lower portion of the driven wheel protrudes outwards to be provided with several second clamping blocks matched with the inner wall of the sheath.

According to the foregoing rotary nozzle structure, the fixed cover extends downwards to be provided with several third clamping blocks matched with the bayonets, and an upper portion of the fixed cover protrudes outwards to be provided with a lug boss.

According to the foregoing rotary nozzle structure, the nozzle seat sheath is mounted on the lug boss of the fixed cover through the nut.

According to the foregoing rotary nozzle structure, the rotating seat and the first center rod are fixedly mounted through a U-shaped pin.

According to the foregoing rotary nozzle structure, the first center rod and the second center rod are fixed through the U-shaped pin.

According to the foregoing rotary nozzle structure, further includes a gun barrel shell, where the two gun barrel shells are mounted through screws, and the gun barrel shell is sleeved on an outer portion of a lower end of the sheath, an outer portion of a lower end of the first center rod, and an outer portion of the second center rod.

According to the foregoing rotary nozzle structure, the sheath includes a first portion and a second portion. The first portion is mounted on the second portion, the first portion and the second portion form a stepped structure, the first portion is sleeved on an outer portion of part of the first reset spring, the driven wheel, the fixed cover, the rotating seat and the nozzle seat structure, two opposite ends of the second portion are respectively provided with a sliding block, the opposite ends of the two gun barrel shells are both provided with a sliding groove, the second portion extends into the two gun barrel shells in a sliding manner through the sliding block and the sliding groove, and the second portion is sleeved on the remaining part of the first reset spring, the annular portion, and part of the first center rod.

According to the foregoing rotary nozzle structure, the rotating seat includes a first step portion and a second step portion. The first step portion and the second step portion are in a step shape, a lower end of the first step portion is of a first sawtooth structure, a second sawtooth structure matched with the first sawtooth structure is arranged inside the driven wheel, and the second step portion is located inside the nozzle seat sheath.

Compared with the prior art, the above technical solution has the following beneficial effects:
an application of the present invention provides a rotary nozzle structure. According to the device, the driven wheel is driven to rotate by moving the sheath, the driven wheel drives the fixed cover to rotate, the fixed cover drives a nozzle to perform a first step of rotation, and drives the nozzle to perform a second step of rotation through a reset action of the reset spring, so that the nozzle moves to a specified position, the nozzle is replaced, and different types of nozzles can be replaced. The manner of replacing the nozzle is simpler and faster, and working efficiency is effectively improved.

### BRIEF DESCRIPTION OF THE DRAWINGS

FIG. 1 is an exploded view of a rotary nozzle structure according to the present invention;

FIG. 2 is a sectional view of a rotary nozzle structure according to the present invention;

FIG. 3 is a schematic diagram of a first-step mounting of a rotary nozzle structure according to the present invention;

FIG. 4 is a schematic diagram of a second-step mounting of a rotary nozzle structure according to the present invention;

FIG. 5 is a schematic diagram of a third-step mounting of a rotary nozzle structure according to the present invention; and

FIG. 6 is an assembly diagram of a rotary nozzle structure according to the present invention.

1. nozzle; 2. nozzle seat; 3. nozzle seat sealing ring; 4. rectifier; 5. nozzle seat sheath; 6. rotating seat; 7. nut; 8. fixed cover; 9. driven wheel; 10. sheath; 11. gun barrel shell; 12. second reset spring; 13. connecting rod sealing ring; 14. second center rod; 15. second center rod sealing ring; 16. locking nut; 17. first clamping block; 18. first center rod; 19. first center rod sealing ring; 20. first reset spring; 21. rotating seat sealing ring; 22. U-shaped pin; 23. nozzle seat spring; 24. bayonet; 25. second clamping block; 26. third clamping block; 27. lug boss; 28. first portion; 29. second portion; 30. sliding block; 31. sliding groove; 32. first sawtooth structure; 33. second sawtooth structure; 34. first step portion; 35. second step portion; 36. annular portion.

### DETAILED DESCRIPTION OF THE EMBODIMENTS

The present invention is described in more detail with reference to the accompanying drawings and specific embodiments, but is not intended to limit the present invention.

The structures, proportions, sizes, etc. shown in the accompanying drawings of the specification are only intended for matching the content disclosed herein and facilitating the understanding and reading of those skilled in the art rather than for limiting the implementation conditions of the present invention. Therefore, they have no technically substantial significance, and any structural modifications, changes in proportions, or adjustments in size, without affecting the effects and objectives that the present invention can produce and achieve, shall still fall within the scope of technical content disclosed in the present invention. Meanwhile, the terms such as “upper”, “lower”, “left”, “right”, “middle”, and “one” as used herein are only for the convenience of description rather than for limiting the implementation scope of the present invention, and changes or adjustments in their relative relationships, without substantially changing the technical content, shall also be deemed to fall within the implementation scope of the present invention.

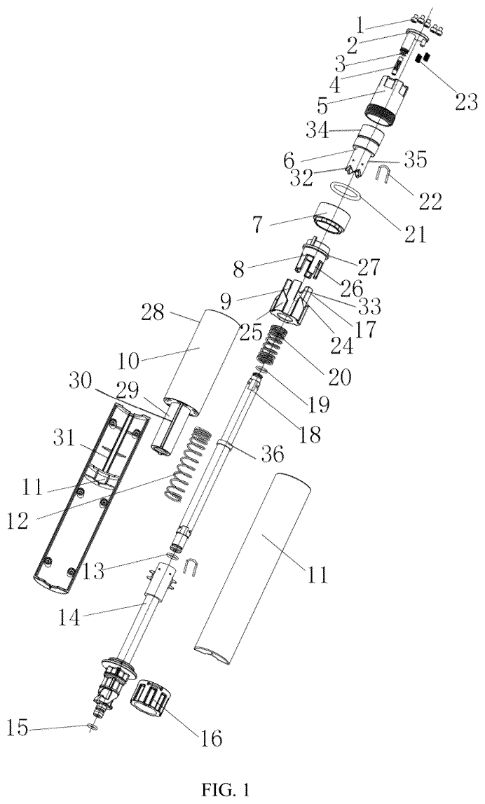

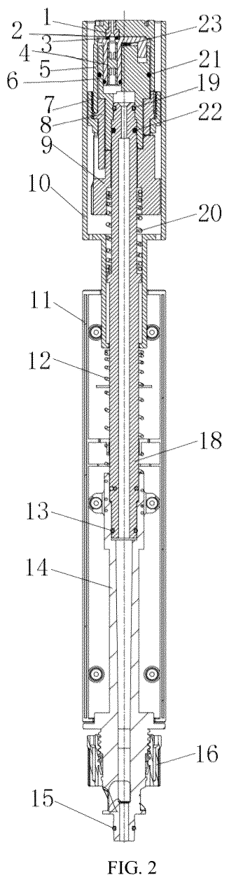

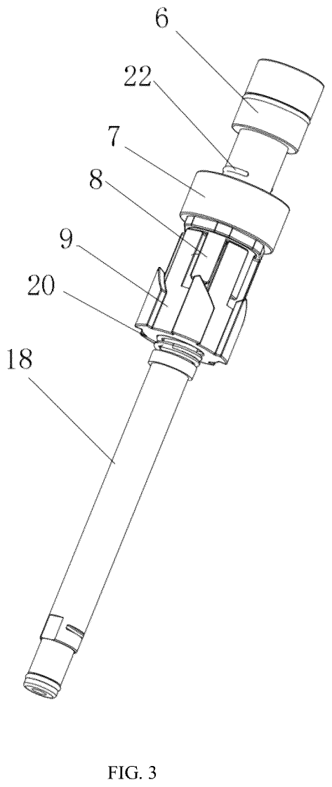

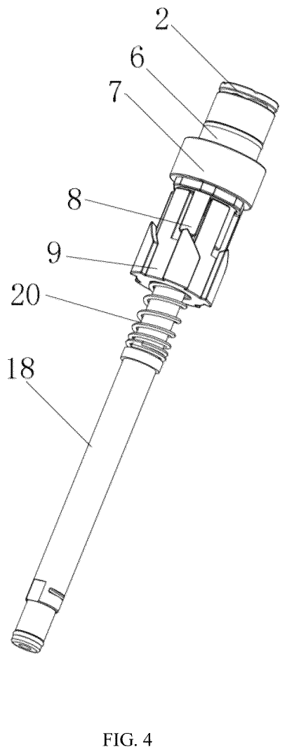

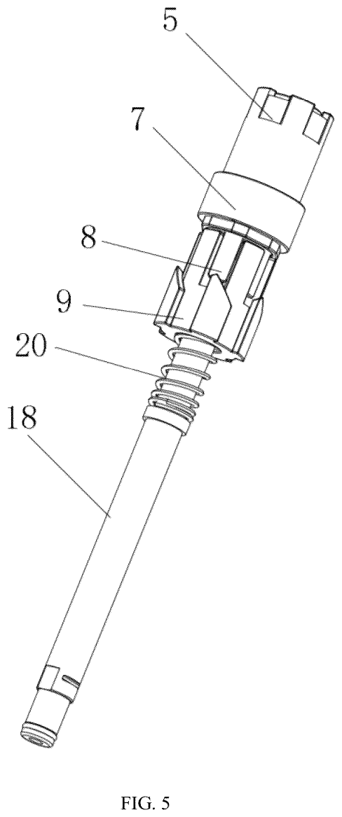

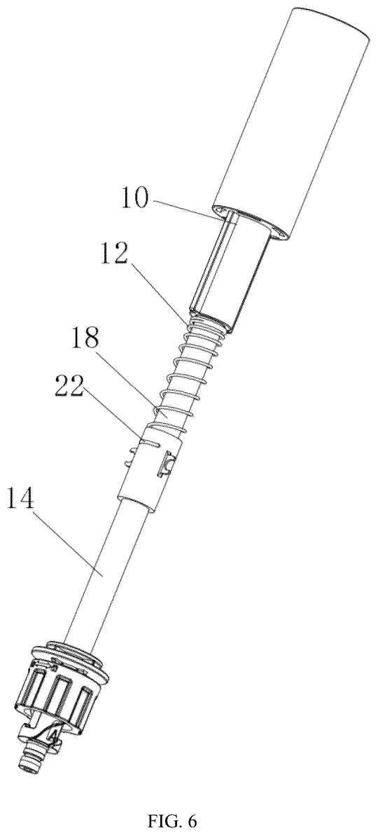

The FIG. 1 to FIG. 6 show a rotary nozzle structure according to a preferred embodiment, including: a first center rod 18, a first reset spring 20, a driven wheel 9, a fixed cover 8, a nut 7, a nozzle seat structure, a sheath 10, a second reset spring 12, a second center rod 14, and a locking nut 16.

A middle portion of the first center rod 18 protrudes outwards to form an annular portion 36; the first reset spring 20, the driven wheel 9, the fixed cover 8 are sequentially sleeved on an upper end of the first center rod 18, where two ends of the first reset spring 20 respectively abut against the annular portion 36 and the driven wheel 9, and the driven wheel 9 is in matched transmission with the fixed cover 8; a rotating seat 6 extends into the fixed cover 8 and is sleeved on the first center rod 18, and the rotating seat 6 is matched with the driven wheel 9 through a sawtooth structure; the nozzle seat structure is sleeved on the rotating seat 6 and is fixedly mounted on the fixed cover 8 through the nut 7; the sheath 10 is mounted on the upper end of the first center rod 18, and an inner wall of the sheath 10 is in matched transmission with the driven wheel 9 through a clamping point structure; the second reset spring 12 is sleeved on a lower end of the first center rod 18; the second center rod 14 is mounted on the first center rod 18, and two ends of the second reset spring 12 respectively abut against the sheath 10 and the second center rod 14; and the locking nut 16 is mounted on the second center rod 14.

The device has the following use method:
the nozzle seat structure and the fixed cover 8 are fixed together through the nut 7, and in a first step of movement, the sheath 10 is held by a hand, so that the sheath 10 moves in a direction of the second center rod 14, here for downwards movement. In a movement process of the sheath 10, the driven wheel 9 is driven to rotate through the clamping point structure, the driven wheel 9 drives the fixed cover 8 to rotate through the clamping point structure, and since the fixed cover 8 is fixed to the nozzle seat structure, the nozzle seat structure is driven to rotate by a certain angle, so that the nozzle 1 on the nozzle seat structure rotates by a certain angle. In a second step of movement, through the movement of the first step, the nozzle 1 rotates by the certain angle but does not reach a specified position, the sheath 10 is released by the hand, the second reset spring 12 recovers deformation to push the sheath 10 return to an initial position, and the driven wheel 9 moves upwards under the action of the first reset spring 20. During the movement, the driven wheel 9 drives the fixed cover 8 to rotate again through the sawtooth structure in which the rotating seat 6 is matched with the driven wheel 9, so that the nozzle seat structure rotates again. In this case, the nozzle 1 on the nozzle seat structure moves to a specified position, and the movement ends. In this device, different types of nozzles are replaced by rotating the nozzle.

On the basis of the foregoing, the present invention further has the following implementation:

Further, a rotary nozzle structure is provided, where the nozzle seat structure includes: a rectifier 4, a nozzle seat spring 23, a nozzle seat 2, a nozzle seat sheath 5, and a nozzle 1. The nozzle seat sheath 5 is sleeved on the rotating seat 6 and is fixedly mounted on the fixed cover 8 through the nut 7, an upper end of the rotating seat 6 is provided with a first mounting hole and a second mounting hole, the rectifier 4 is mounted on the nozzle seat 2, the nozzle seat 2 is correspondingly mounted on the first mounting hole and the second mounting hole, and the nozzle seat spring 23 is located between the nozzle seat 2 and the rotating seat 6, and the several nozzles 1 are mounted on the nozzle seat sheath 5. Specifically, when the fixed cover 8 rotates, the fixed cover 8 drives the nozzle seat sheath 5 to rotate, and the nozzle seat sheath 5 directly drives the nozzle 1 to rotate, so that the nozzle 1 is replaced.

Further, the rotary nozzle structure is provided, where the driven wheel 9 extends upwards to be provided with several first clamping blocks 17, a bayonet 24 is formed between every two adjacent first clamping blocks 17, and a lower portion of the driven wheel 9 protrudes outwards to be provided with several second clamping blocks 25 matched with the inner wall of the sheath 10. Specifically, the inner wall of the sheath 10 is provided with the bayonet capable of being matched with the second clamping block 25, and the sheath 10 and the driven wheel 9 are mounted in a matched manner through the bayonet and the second clamping block 25, so that when the sheath 10 is held by the hand to rotate the sliding sleeve 10, the driven wheel 9 is driven to rotate.

Further, the rotary nozzle structure is provided, where the fixed cover 8 extends downwards to be provided with several third clamping blocks 26 matched with the bayonets, and an upper portion of the fixed cover 8 protrudes outwards to be provided with a lug boss 27. Specifically, the third clamping block 26 at the lower end of the fixed cover 8 extends into the bayonet 24 on the driven wheel 9, so that a matching mounting of the bayonet structure is realized between the fixed cover 8 and the driven wheel 9, and the driven wheel 9 rotates to drive the fixed cover 8 to rotate.

Further, the rotary nozzle structure is provided, where the nozzle seat sheath 5 is mounted on the lug boss 27 of the fixed cover 8 through the nut 7. Specifically, the lug boss 27 is arranged on an outer wall of the fixed cover 8 and cannot completely pass through the nut 7. The nozzle seat sheath 5 is provided with an external thread structure, and the nozzle seat sheath 5, the nut 7 and the fixed cover 8 are fixed together through the nut 7.

Further, the rotary nozzle structure is provided, where the rotating seat 6 and the first center rod 18 are fixedly mounted through a U-shaped pin 22.

Further, the rotary nozzle structure is provided, where the first center rod 18 and the second center rod 14 are fixed through the U-shaped pin. Specifically, a pipe sleeve with a larger diameter is arranged at one end, facing the first center rod 18, of the second center rod 14, and an inner wall of the pipe sleeve and the first center rod 18 are mounted in a matched manner through a clamping point.

Further, the rotary nozzle structure is provided, further including a gun barrel shell 11, where the two gun barrel shells 11 are mounted through screws, and the gun barrel shell 11 is sleeved on an outer portion of a lower end of the sheath 10, an outer portion of a lower end of the first center rod 18, and an outer portion of the second center rod 14. Specifically, when the two gun barrel shells 11 are mounted, firstly, one of the gun barrel shells 11 can be fixedly mounted on the second center rod 14, and then the two gun barrel shells 11 are mounted in alignment. In the device, two mounting portions are arranged on the second center rod 14, and one of the gun barrel shells 11 is mounted on the mounting portion through a screw.

Further, the rotary nozzle structure is provided, where the sheath 10 includes a first portion 28 and a second portion 29. The first portion 28 is mounted on the second portion 29, the first portion 28 and the second portion 29 form a stepped structure, the first portion 28 is sleeved on an outer portion of part of the first reset spring 20, the driven wheel 9, the fixed cover 8, the rotating seat 6 and the nozzle seat structure, two opposite ends of the second portion 29 are respectively provided with a sliding block 30, the opposite ends of the two gun barrel shells 11 are both provided with a sliding groove 31, the second portion 29 extends into the two gun barrel shells 11 in a sliding manner through the sliding block 30 and the sliding groove 31, and the second portion 29 is sleeved on the remaining part of the first reset spring 20, the annular portion 36, and part of the first center rod 18. Specifically, the sheath 10 is composed of two portions, a diameter of the second portion 29 is smaller than that of the first portion 28. By sliding the sheath 10, the second portion 29 can extend into or extend out of the two gun barrel shells 11 through the sliding block 30 and the sliding groove 31.

Further, the rotary nozzle structure is provided, where the rotating seat 6 includes a first step portion 34 and a second step portion 35. The first step portion 34 and the second step portion 35 are in a step shape, a lower end of the first step portion 34 is of a first sawtooth structure 32, a second sawtooth structure 33 matched with the first sawtooth structure 32 is arranged inside the driven wheel 9, and the second step portion 35 is located inside the nozzle seat sheath 5. Specifically, the lower end of the rotating seat 6 penetrates through the fixed cover 8 and extends into the driven wheel 9, so that the first sawtooth structure 32 and the second sawtooth structure 33 are mounted in a matched manner. When moving to the second step, the driven wheel 9 and the rotating seat 6 are in matched transmission through the first sawtooth structure 32 and the second sawtooth structure 33, so that the rotating seat 6 and the driven wheel 9 are in matched transmission through the sawtooth structure, and then the fixed cover 8 rotates again.

The device has the following mounting step:

Step 1: sequentially mounting a nozzle seat sealing ring 3, a connecting rod sealing ring 13, a second center rod sealing ring 15, a first center rod sealing ring 19 and the rotating seat sealing ring 21 at the nozzle seat 2, one end of the first center rod 18, the second center rod 14, the other end of first center rod 18, and the rotating seat 6.

Step 2: sequentially sleeving the first reset spring 20, the driven wheel 9, the fixed cover 8, the nut 7, and the rotating seat 6 on the first center rod 18, and pressing the first reset spring 20 to insert the U-shaped pin 22 into a specified position.

Step 3: placing the rectifier 4 and the nozzle seat spring 23 into a hole specified in the rotating seat 6 firstly and then placing into the nozzle seat 2.

Step 4: loading the nozzle seat sheath 5, and fixing the nozzle seat sheath 5 to the fixed cover 8 by tightening the nut 7.

Step 5: loading the sheath 10 and the second reset spring 12 from the bottom, inserting the second center rod 14, and fixing together through the U-shaped pin 22.

Step 6: fixedly mounting the two gun barrel shells 11 on the second center rod 14, respectively.

The foregoing descriptions are merely preferred embodiments of the present invention, and are not intended to limit the implementations and the scope of protection of the present invention. A person of ordinary skill in the art should be aware that the solutions obtained by applying equivalent replacements and obvious changes made by using the description and drawings of the present invention should be included in the protection scope of the present invention.

What is claimed is:

1. A rotary nozzle structure, comprising:
a first center rod, a first reset spring, a driven wheel, a fixed cover, a rotating seat, a nut, a nozzle seat structure, a sheath, a second reset spring, a second center rod, and a locking nut; wherein
a middle portion of the first center rod protrudes outwards to form an annular portion;
the first reset spring, the driven wheel, the fixed cover are sequentially sleeved on an upper end of the first center rod, wherein two ends of the first reset spring respectively abut against the annular portion and the driven wheel, and the driven wheel is in matched transmission with the fixed cover;
the rotating seat extends into the fixed cover and is sleeved on the first center rod, and the rotating seat is matched with the driven wheel through a sawtooth structure;
the nozzle seat structure is sleeved on the rotating seat and is fixedly mounted on the fixed cover through the nut;
the sheath is mounted on the upper end of the first center rod, and an inner wall of the sheath is in matched transmission with the driven wheel through a clamping point structure;
the second reset spring is sleeved on a lower end of the first center rod;
the second center rod is mounted on the first center rod, and two ends of the second reset spring respectively abut against the sheath and the second center rod; and
the locking nut is mounted on the second center rod.

2. The rotary nozzle structure according to claim 1, wherein the nozzle seat structure comprises: a rectifier, a nozzle seat spring, a nozzle seat, a nozzle seat sheath, and a nozzle; the nozzle seat sheath is sleeved on the rotating seat and is fixedly mounted on the fixed cover through the nut, an upper end of the rotating seat is provided with a first mounting hole and a second mounting hole, the rectifier is mounted on the nozzle seat, the nozzle seat is correspondingly mounted on the first mounting hole and the second mounting hole, and the nozzle seat spring is located between the nozzle seat and the rotating seat, and the several nozzles are mounted on the nozzle seat sheath.

3. The rotary nozzle structure according to claim 1, wherein the driven wheel extends upwards to be provided with several first clamping blocks, a bayonet is formed between every two adjacent first clamping blocks, and a lower portion of the driven wheel protrudes outwards to be provided with several second clamping blocks matched with the inner wall of the sheath.

4. The rotary nozzle structure according to claim 3, wherein the fixed cover extends downwards to be provided with several third clamping blocks matched with the bayonets, and an upper portion of the fixed cover protrudes outwards to be provided with a lug boss.

5. The rotary nozzle structure according to claim 4, wherein the nozzle seat sheath is mounted on the lug boss of the fixed cover through the nut.

6. The rotary nozzle structure according to claim 1, wherein the rotating seat and the first center rod are fixedly mounted through a U-shaped pin.

7. The rotary nozzle structure according to claim 1, wherein the first center rod and the second center rod are fixed through the U-shaped pin.

8. The rotary nozzle structure according to claim 1, further comprising a gun barrel shell, wherein the two gun barrel shells are mounted through screws, and the gun barrel shell is sleeved on an outer portion of a lower end of the sheath, an outer portion of a lower end of the first center rod, and an outer portion of the second center rod.

9. The rotary nozzle structure according to claim 8, wherein the sheath comprises a first portion and a second portion; the first portion is mounted on the second portion, the first portion and the second portion form a stepped structure, the first portion is sleeved on an outer portion of part of the first reset spring, the driven wheel, the fixed cover, the rotating seat and the nozzle seat structure, two opposite ends of the second portion are respectively provided with a sliding block, the opposite ends of the two gun barrel shells are both provided with a sliding groove, the second portion extends into the two gun barrel shells in a sliding manner through the sliding block and the sliding groove, and the second portion is sleeved on the remaining part of the first reset spring, the annular portion, and part of the first center rod.

10. The rotary nozzle structure according to claim 2, wherein the rotating seat comprises a first step portion and a second step portion, the first step portion and the second step portion are in a step shape, a lower end of the first step portion is of a first sawtooth structure, a second sawtooth structure matched with the first sawtooth structure is arranged inside the driven wheel, and the second step portion is located inside the nozzle seat sheath.
